(19) United States
(12) Patent Application Publication
(10) Pub. No.: US 2016/0134147 A1
(43) Pub. Date: May 12, 2016

(54) Battery Energy Storage System and Controlling Method

(71) Applicant: FIREBRIGHT1 GREEN ENERGY(SHANGHAI) LIMITED., Shanghai (CN)

(72) Inventors: Fang Shen, Shanghai (CN); Jie Chen, Shanghai (CN)

(21) Appl. No.: 14/898,105

(22) PCT Filed: Jun. 13, 2013
(86) PCT No.: PCT/CN2013/077192

§ 371 Date: Dec. 11, 2015

(51) Int. Cl. H02J 7/00

(52) U.S. Cl. CPC H02J 7/0065; H02J 7/007; H02J 2007/0067

(57) ABSTRACT

The invention relates to a battery energy storage system (10) and controlling method, wherein the battery energy storage system comprising: an input (102) capable of connecting with a grid; a first output (104) capable of connecting with a first load; a charge controller (108) connected to the input (102) and adapted to convert an alternating current power supply from the input (102) to a direct current power supply; a battery (110) connected to the charge controller (108) and adapted to store the direct current power supply converted by the charge controller (108); an inverter (112) connected to the battery (110) and the first output (104) and adapted to convert a direct current power supply stored in the battery (110) to an alternating current power supply and output the converted alternating current power supply to the first output (104); a first switch (114) connected to the input (102) and the first output (104); and an energy management system (118) adapted to control the charge controller (108), the inverter (112) and the first switch (104), wherein the energy management system (118) turns on the first switch (104) when the energy management system (118) detects that there is energy on the input (102) and turns off the first switch (104) when the energy management system (118) detects that there is no energy on the input (102). With the battery energy storage system (10) and the controlling method, the load power is not limited by the drive capability of the inverter of the battery energy storage system (10).

### TECHNICAL FIELD

The invention relates to an energy storage technology, and particularly to battery energy storage system and controlling method.

### BACKGROUND

Battery energy storage system (BESS) has recently emerged as one of the most promising technology for use in power system that offers solutions to many operational problems faced by today power system.

FIG. 1 illustrates a typical system diagram of the existed BESS. As shown in FIG. 1, the existed BESS includes an alternating current (AC) input AC In capable of connecting with a grid, an AC output AC Out capable of connecting with a load, a charge controller, a battery, an inverter INV, and an energy management system (EMS). The charge controller may convert AC from the grid to a direct current (DC). The battery may store the DC converted by the charge controller. The inverter INV may convert DC stored in the battery to an AC and output the converted AC to the output AC Out. The EMS may control AC-DC conversion of the charge controller and DC-AC conversion of the inverter INV.

According to the existed BESS, load power is provided only by the inverter INV of the BESS, and thus the load power is limited by the drive capability of the inverter. That is, if the inverter of the BESS is 10 kw for example, the load can not exceed 10 kw.

### SUMMARY

In consideration of the above problems of the prior art, embodiments of the invention provide battery energy storage system and controlling method, with which the load power is not limited by the drive capability of the inverter of the battery energy storage system.

Embodiments of the invention provides a battery energy storage system (10) comprising: an input (102) capable of connecting with a grid; a first output (104) capable of connecting with a first load; a charge controller (108) connected to the input (102) and adapted to convert an alternating current power supply from the input (102) to a direct current power supply; a battery (110) connected to the charge controller (108) and adapted to store the direct current power supply converted by the charge controller (108); an inverter (112) connected to the battery (110) and the first output (104) and adapted to convert a direct current power supply stored in the battery (110) to an alternating current power supply and output the converted alternating current power supply to the first output (104); a first switch (114) connected to the input (102) and the first output (104); and an energy management system (118) adapted to control the charge controller (108), the inverter (112) and the first switch (104), wherein the energy management system (118) turns on the first switch (104) when the energy management system (118) detects that there is energy on the input (102) and turns off the first switch (104) when the energy management system (118) detects that there is no energy on the input (102).

Wherein the battery energy storage system (10) further comprises: a second output (106) capable of connecting with a second load; and a second switch (116) connected between the second output (106) and the input (102), which is controlled by the energy management system (118), wherein the energy management system (118) turns on the second switch (106) when the energy management system (118) detects that there is energy on the input (102) and turns off the second switch (106) when the energy management system (118) detects that there is no energy on the input (102).

Embodiments of the invention provides a controlling method executed by an energy management system (118) included in a battery energy storage system (10), wherein the battery energy storage system (10) further comprises: an input (102) capable of connecting with a grid; a first output (104) capable of connecting with a first load; a charge controller (108) connected to the input (102) and adapted to convert an alternating current power supply from the input (102) to a direct current power supply; a battery (110) connected to the charge controller (108) and adapted to store the direct current power supply converted by the charge controller (108); an inverter (112) connected to the battery (110) and the first output (104) and adapted to convert a direct current power supply stored in the battery (110) to an alternating current power supply and output the converted alternating current power supply to the first output (104); a first switch (114) connected to the input (102) and the first output (114), wherein the energy management system (118) is adapted to control the charge controller (108), the inverter (112) and the first switch (104), the controlling method comprising: detecting whether there is energy on the input; and turning on the first switch (114) when it is detected that there is energy on the input (102); and turning off the first switch (114) when it is detected that there is energy on the input (102).

wherein the battery energy storage system (10) further comprises: a second output (106) capable of connecting with a second load; and a second switch (116) connected between the second output (106) and the input (102), which is controlled by the energy management system (118), the controlling method further comprising: turning on the second switch (106) when it is detected that there is energy on the input (102); and turning off the second switch (106) when it is detected that there is no energy on the input (102).

In embodiments of the invention, the first load is provided with power supply by both the inverter of the battery energy storage system and the grid, and thus the load power of the first load is not limited by the drive capability of the inverter of the battery energy storage system.

### BRIEF DESCRIPTION OF THE DRAWINGS

These and other aspects of the invention will be better understood with reference to the following description, drawings and appended claims.

FIG. 1 illustrates a typical system diagram of the existed battery energy storage system.

FIG. 2 illustrates a system diagram of a battery energy storage system according to an embodiment of the invention.

FIG. 3 illustrates a flowchart of a controlling method executed by an energy management system according to an embodiment of the invention.

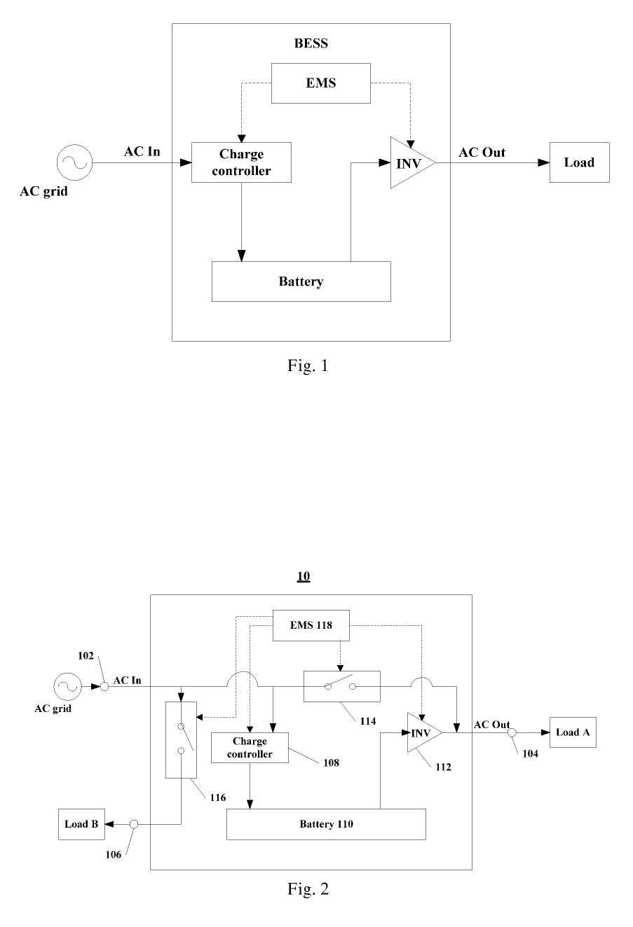

### DETAILED DESCRIPTION

Embodiments of the invention are described with reference to the accompanying figures below.

FIG. 2 illustrates a system diagram of a battery energy storage system according to an embodiment of the invention. As shown in FIG. 2, the battery energy storage system 10 may include an input 102 capable of connecting with an AC grid, an output 104 capable of connecting with load A, an output 106 capable of connecting with load B, a charge controller 108, a battery 110, an inverter 112, a switch 114, a switch 116 and an energy management system (EMS) 118.

The charge controller 108 is connected to the input 102 and the battery 110. The charge controller 108 is adapted to convert an alternating current (AC) power supply from the input 102 to a direct current (DC) power supply and output the converted DC power supply to the battery 110. For example, the charge controller 108 may be but not limited to an AC-DC converter.

The battery 110 is connected to the charge controller 108 and is adapted to store the DC power supply converted by the charge controller 108.

The inverter 112 is connected to the battery 110 and the output 104 and is adapted to convert a DC power supply stored in the battery 110 to an AC power supply and output the converted AC power supply to the output 104.

The switch 114 may be connected between the input 102 and the output 104. The switch 116 may be connected between the input 102 and the output 106.

The EMS 118 may be connected to the input 102, the charge controller 108, the inverter 112, the switch 114 and the switch 116. The EMS 118 is adapted to control the charge controller 108, the inverter 112, the switch 114 and the switch 116, wherein controlling of the charge controller 108 and the inverter 112 by the EMS 118 is known for those skilled in the art and thus its detailed description is omitted. The EMS 118 detects whether there is energy on the input 102, wherein there is energy on the input 102 when the AC grid has power and there is no energy on the input 102 when the AC grid has power outage. When it is detected that there is energy on the input 102, the EMS 118 may turn on the switch 114 and the switch 116 so that the AC power supply from the AC grid is sent to load 1 and load 2 from the input 102. When it is detected that there is no energy on the input 102, the EMS 118 may turn off the switch 114 and the switch 116. For example, the EMS 118 is implemented by a processor, a controller, an integrated circuit or the like.

It is clear from the above description that when there is energy on the input 102, load A is provided with power supply by both the inverter 112 and the AC grid and load B is provided with power supply by the AC grid, and thus the load power of load A and the load power of load B are not limited by the drive capability of the inverter 112.

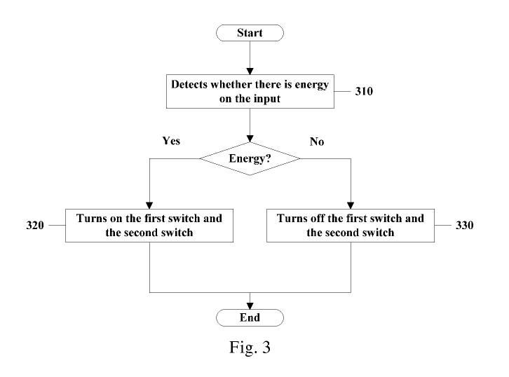

Now referring to FIG. 3, which illustrates a flowchart of a controlling method executed by the EMS 118 according to an embodiment of the invention. As shown in FIG. 3, at Step 310, the EMS 118 may detect whether there is energy on the input 102, wherein there is energy on the input 102 when the AC grid has power and there is no energy on the input 102 when the AC grid has power outage. At Step 320, the EMS 118 may turn on the switch 114 and the switch 116 when the detecting at Step 310 indicates that there is energy on the input 102, so that the AC power supply from the AC grid is sent to load 1 and load 2 from the input 102. At Step 330, the EMS 118 may turn off the switch 114 and the switch 116 when the detecting at Step 310 indicates that there is no energy on the input 102.

### Other Modifications

Those skilled in the art will understand that in the above embodiment, the battery energy storage system 10 includes the output 106 and the switch 116, but the invention is not so limited. In some other embodiments of the invention, the battery energy storage system 10 does also not include the output 106 and the switch 116.

Although the invention has been described with reference to the embodiments, those skilled in the art will appreciate that many variations and modifications may be made to the invention without departing from the spirit and essence of the invention, and the scope of the invention is defined by the appended claims.

1. A battery energy storage system (10), comprising:
an input (102) capable of connecting with a grid;
a first output (104) capable of connecting with a first load;
a charge controller (108) connected to the input (102) and adapted to convert an alternating current power supply from the input (102) to a direct current power supply;
a battery (110) connected to the charge controller (108) and adapted to store the direct current power supply converted by the charge controller (108);
an inverter (112) connected to the battery (110) and the first output (104) and adapted to convert a direct current power supply stored in the battery (110) to an alternating current power supply and output the converted alternating current power supply to the first output (104);
a first switch (114) connected to the input (102) and the first output (104); and
an energy management system (118) adapted to control the charge controller (108), the inverter (112) and the first switch (104),
wherein the energy management system (118) turns on the first switch (104) when the energy management system (118) detects that there is energy on the input (102) and turns off the first switch (104) when the energy management system (118) detects that there is no energy on the input (102).

2. The battery energy storage system (10) of claim 1, wherein further comprising:
a second output (106) capable of connecting with a second load; and
a second switch (116) connected between the second output (106) and the input (102), which is controlled by the energy management system (118),
wherein the energy management system (118) turns on the second switch (106) when the energy management system (118) detects that there is energy on the input (102) and turns off the second switch (106) when the energy management system (118) detects that there is no energy on the input (102).

3. A controlling method executed by an energy management system (118) included in a battery energy storage system (10), wherein the battery energy storage system (10) further comprises: an input (102) capable of connecting with a grid; a first output (104) capable of connecting with a first load; a charge controller (108) connected to the input (102) and adapted to convert an alternating current power supply from the input (102) to a direct current power supply; a battery (110) connected to the charge controller (108) and adapted to store the direct current power supply converted by the charge controller (108); an inverter (112) connected to the battery (110) and the first output (104) and adapted to convert a direct current power supply stored in the battery (110) to an alternating current power supply and output the converted alternating current power supply to the first output (104); a first switch (114) connected to the input (102) and the first output (114), wherein the energy management system (118) is adapted to control the charge controller (108), the inverter (112) and the first switch (104), the controlling method comprising:
detecting whether there is energy on the input; and
turning on the first switch (114) when it is detected that there is energy on the input (102); and
turning off the first switch (114) when it is detected that there is energy on the input (102).

4. The controlling method of claim 3, wherein
the battery energy storage system (10) further comprises: a second output (106) capable of connecting with a second load; and a second switch (116) connected between the second output (106) and the input (102), which is controlled by the energy management system (118),
the controlling method further comprising:
turning on the second switch (106) when it is detected that there is energy on the input (102); and
turning off the second switch (106) when it is detected that there is no energy on the input (102).
